(19) United States
(12) Patent Application Publication
(10) Pub. No.: US 2021/0009478 A1
(43) Pub. Date: Jan. 14, 2021

(54) GREEN SHEET PRODUCING BINDER COMPOSITION, BAKING SLURRY COMPOSITION, METHOD FOR MANUFACTURING GREEN SHEET, METHOD FOR MANUFACTURING SINTERED PRODUCT, AND METHOD FOR MANUFACTURING MONOLITHIC CERAMIC CAPACITOR

(71) Applicant: GOO CHEMICAL CO., LTD., Kyoto (JP)

(72) Inventor: Yutaka KAWAI, Kyoto (JP)

(21) Appl. No.: 17/043,012

(22) PCT Filed: Mar. 13, 2019
(86) PCT No.: PCT/JP2019/010212

§ 371 Date: Sep. 29, 2020

(51) Int. Cl. C04B 35/634; H01G 4/30

(52) U.S. Cl. CPC C04B 35/63416; C04B 2235/602; H01G 4/30

(57) ABSTRACT

A green sheet producing binder composition of the present invention is a binder composition for producing a green sheet. The binder composition contains a polyvinyl alcohol resin. The polyvinyl alcohol resin contains at least two kinds of components having degrees of hydrophilicity different from each other.

### CROSS-REFERENCE TO RELATED APPLICATION

This is the U.S. national stage of application No. PCT/JP2019/010212, filed on Mar. 13, 2019.

### TECHNICAL FIELD

The present invention relates to green sheet producing binder compositions, baking slurry compositions, methods for manufacturing the green sheets, methods for manufacturing sintered products, and methods for manufacturing monolithic ceramic capacitors. More specifically, the present invention relates to a binder composition for producing a green sheet, a baking slurry composition for producing a sintered product of inorganic powder, a method for manufacturing the green sheet containing a dried product of the baking slurry composition, a method for manufacturing the sintered product of the baking slurry composition, and a method for manufacturing a monolithic ceramic capacitor containing the sintered product of the green sheet.

### BACKGROUND ART

Conventionally, an organic solvent, such as typically toluene, has been blended as a solvent with a baking binder composition, a baking slurry composition, and the like for producing a ceramic green sheet.

In recent years, emission regulations and the like for organic solvents have been strengthened with concerns about the effects of volatile organic compounds (VOCs) and the like on the environment and the human body. For this reason, a solvent to be blended with a baking binder composition, a baking slurry composition, and the like is required to be converted from an organic solvent into an aqueous solvent.

For example, Patent Literature 1 discloses a molding binder containing, as a main component, modified polyvinyl alcohol having a side chain attached to a hydrophobic group having a four or more-carbon hydrocarbon or attached to both a hydrophobic group having a four or more-carbon hydrocarbon and an ionic hydrophilic group. It is disclosed that even when the molding binder contains an aqueous solvent, a green sheet can be molded from the molding binder.

When a slurry composition is prepared from the binder composition which is disclosed in Patent Literature 1, which is aqueous, and which is adopted for molding of a ceramic green sheet, the storage stability of the binder composition in water may be degraded. In addition, when the slurry composition is prepared from the binder composition, and a sheet is formed from the slurry composition by application of the slurry composition by a printing method or the like, unevenness and repellency may occur in the sheet. This leads to a problem of a reduction of the smoothness, strength, and flexibility of the sheet.

### CITATION LIST

### Patent Literature

Patent Literature 1: JP S59-156959 A

### SUMMARY OF INVENTION

It is an object of the present invention to provide: a green sheet producing binder composition; and a baking slurry composition including the binder composition, wherein the green sheet producing binder composition has storage stability in an aqueous system in the case of a slurry composition produced from the green sheet producing binder composition, and while a high degree of smoothness in the case of a sheet formed from the green sheet producing binder composition is maintained, the green sheet producing binder composition enables strength and flexibility to be imparted to the sheet.

It is another object of the present invention to provide: a method for manufacturing a green sheet; a method for manufacturing a sintered product; and a method for manufacturing a monolithic ceramic capacitor, wherein while a high degree of smoothness in the case of a sheet formed from the binder composition is maintained, the sheet can have increased strength and flexibility.

A green sheet producing binder composition according to one aspect of the present invention is a binder composition for producing a green sheet. The binder composition contains a polyvinyl alcohol resin (C). The polyvinyl alcohol resin (C) contains at least two kinds of components having degrees of hydrophilicity different from each other.

A baking slurry composition according to one aspect of the present invention contains the binder composition, inorganic powder (B), and water.

A method for manufacturing a green sheet according to one aspect of the present invention includes applying and drying the baking slurry composition.

A method for manufacturing a sintered product according to one aspect of the present invention includes sintering a green sheet obtained by the method for manufacturing the green sheet.

A method for manufacturing a monolithic ceramic capacitor according to one aspect of the present invention includes sintering a stack obtained by stacking a plurality of green sheets obtained by the method for manufacturing the green sheet.

### DESCRIPTION OF EMBODIMENTS

A green sheet producing binder composition according to the present embodiment is a binder composition (hereinafter also referred to as a binder composition (X)) adopted to produce a green sheet. The binder composition (X) contains a polyvinyl alcohol resin (C), and the polyvinyl alcohol resin (C) contains at least two kinds of components having degrees of hydrophilicity different from each other. Since the binder composition (X) contains the polyvinyl alcohol resin (C), the binder composition (X) can function as a binder. A baking slurry composition (hereinafter referred to as a slurry composition (Y)) contains the binder composition (X), inorganic powder (B), and water. In the present embodiment, a sheet formed from the slurry compositions (Y) may have increased strength and flexibility. Since the slurry composition (Y) contains the inorganic powder (B), baking the slurry composition (Y) or a sheet (green sheet) formed from the slurry composition (Y) sinters the inorganic powder. Thus, a sintered product is producible from the slurry composition (Y).

The binder composition (X) contains the polyvinyl alcohol resin (C), and therefore, also when a slurry composition (Y) containing an aqueous solvent is prepared from the binder composition (X), the binder composition (X) is easily dissolvable in the slurry composition (Y). Moreover, components in the slurry compositions (Y) are readily dispersible. In particular, the polyvinyl alcohol resin (C) in the binder composition (X) contains the at least two kinds of components having degrees of hydrophilicity different from each other and thus enables the components in the slurry composition (Y) to be efficiently dispersed. Therefore, even when the slurry composition (Y) is prepared from the binder composition (X) in the aqueous solvent, aggregation, gelation, and the like do not easily occur, and thus, the slurry composition (Y) may have high storage stability.

In particular, the binder composition (X) and the slurry composition (Y) contain the polyvinyl alcohol resin (C) including two or more kinds of components having degrees of hydrophilicity different from each other, and therefore, in the case of a sheet formed from the binder composition (X) and the slurry composition (Y), well-balanced contribution of the binder composition (X) and the slurry composition (Y) to the flexibility and the strength of the sheet is possible. This is probably because interaction between a hydrophilic functional group, such as a hydroxyl group, contained in the polyvinyl alcohol resin (C) and a surface of the inorganic powder (B) contributes to the improvement of the strength of the sheet. In addition, changing the degree of hydrophilicity, the ratio, and the like of the at least two components having degrees of hydrophilicity different from each other in the polyvinyl alcohol resin (C) enables the degree of interaction between the inorganic powder (B) and the polyvinyl alcohol resin (C) to be adjusted and enables the strength and the flexibility of the sheet to be easily adjusted. That is, the sheet formed from the slurry composition (Y) containing the binder composition (X) can have both strength and flexibility.

In addition, the polyvinyl alcohol resin (C) contains two or more components having degrees of hydrophilicity different from each other as described above. Thus, the components in the slurry composition (Y) are easily dispersed uniformly. Therefore, when the slurry composition (Y) is applied by printing to form a sheet, unevenness and repellency are less likely to occur in a coating. Thus, the sheet has high printability, and therefore, the sheet formed from the slurry compositions (Y) can have a high degree of smoothness.

In the present specification, “having degrees of hydrophilicity different from each other” means that the degree of water-affinity differs between the plurality of components. It is possible to determine “having degrees of hydrophilicity different from each other” based on, for example, a difference in solubility in water and a difference in water absorption. It can be said that components having different saponification degrees in the polyvinyl alcohol resin (C) have degrees of hydrophilicity different from each other. It can be said that components having different functional groups in the polyvinyl alcohol resin (C) also have degrees of hydrophilicity different from each other. Even when components have the same functional groups, it can be said that the components have degrees of hydrophilicity different from each other if the components have different functional group equivalents.

The green sheet producing binder composition, the baking slurry composition, a green sheet, a sintered product, and a ceramic capacitor according to the present embodiment will be sequentially described in detail below. In the following description, the “green sheet” may simply be referred to as a “sheet”.

<Green Sheet Producing Binder Composition>

The binder composition (X) is a composition for producing a green sheet and functions as a binder. The binder composition (X) is, together with a component such as the inorganic powder (B), included in the slurry composition (Y) for baking, and application and optional drying of the slurry composition (Y) enable the green sheet to be produced.

As described above, the binder composition (X) contains the polyvinyl alcohol resin (C), and the polyvinyl alcohol resin (C) contains at least two kinds of components having degrees of hydrophilicity different from each other. Thus, the slurry composition (Y) containing the binder composition (X) has storage stability. It is also possible to maintain a high degree of smoothness of the sheet formed from the slurry compositions (Y), and the sheet can have satisfactory strength and flexibility.

[Polyvinyl Alcohol Resin (C)]

The degree of hydrophilicity of the polyvinyl alcohol resin (C) may vary depending on its molecule structure, specifically, for example, the kind of a hydrophilic functional group, the number of hydrophilic functional groups, the kind of a hydrophobic functional group, the number of hydrophobic functional groups, and the structure of a main chain. Note that in the present embodiment, the polyvinyl alcohol resin (C) includes at least one member selected from the group consisting of polyvinyl alcohol obtained by fully saponifying poly vinyl acetate, polyvinyl alcohol obtained by partially saponifying polyvinyl acetate, and a modified product obtained by modifying part of a hydroxyl group or part of an acetic acid group (acetyloxy group) of the structure of polyvinyl alcohol.

The polyvinyl alcohol resin (C) is a component which enables the binder composition (X) to function as a binder. In the present embodiment, the polyvinyl alcohol resin (C) contains at least two kinds of components having degrees of hydrophilicity different from each other. Thus, the polyvinyl alcohol resin (C) enables storage stability to be imparted to the slurry compositions (Y) and a high degree of smoothness and flexibility to the sheet. Further, the polyvinyl alcohol resin (C) contains the at least two kinds of components as described above, and therefore, when the slurry composition (Y) is baked, a temperature range of pyrolysis at the time of the baking can be expanded. This can suppress a rapid weight reduction during the baking of the slurry composition (Y). Therefore, it is possible to make it difficult for the sintered product to be cracked.

The polyvinyl alcohol resin (C) preferably has an average degree of polymerization higher than or equal to 500 and lower than or equal to 9000. In this case, the polyvinyl alcohol resin (C) is readily soluble in water. Moreover, in this case, the polyvinyl alcohol resin (C) more easily adsorbs the inorganic powder (B) and thus enables the dispersibility of the inorganic powder (B) in slurry composition (Y) to be further improved. The average degree of polymerization of the polyvinyl alcohol resin (C) is more preferably higher than or equal to 500 and lower than or equal to 4000, and even more preferably higher than or equal to 1500 and lower than or equal to 4000. The average degree of polymerization is calculable from a relative viscosity of the polyvinyl alcohol resin (C) to water, the relative viscosity being obtained by using an Ostwald viscometer after full saponification of the polyvinyl alcohol resin (C) with sodium hydroxide.

Components that may be contained in the polyvinyl alcohol resin (C) will be described in further detail.

The polyvinyl alcohol resin (C) preferably contains at least two kinds of components having different degrees of saponification. Also in this case, the polyvinyl alcohol resin (C) may contain at least two kinds of components having different hydrophilicities. Thus, the polyvinyl alcohol resin (C) can efficiently disperse the components in the slurry compositions (Y). Therefore, even when the slurry composition (Y) is prepared from the binder composition (X) in the aqueous solvent, aggregation, gelation, and the like do not easily occur, and thus, the slurry composition (Y) may have higher storage stability. Moreover, in this case, the degree of interaction between the polyvinyl alcohol resin (C) and the inorganic powder (B) in the slurry composition (Y) is adjustable, and the strength and flexibility of the sheet are more easily adjustable. Furthermore, the polyvinyl alcohol resin (C) contains two or more components having different saponification degrees, and therefore, the components in the slurry composition (Y) are easily dispersed uniformly. Therefore, when the slurry composition (Y) is applied by printing to form a sheet, unevenness and repellency are less likely to occur in the coating. Therefore, the sheet formed from the slurry compositions (Y) can have a higher degree of smoothness. The degree of saponification is calculable by, for example, measuring the polyvinyl alcohol resin in accordance with, for example, JIS K6726 (1994), and based on results of the measuring, it is possible to determine that the degrees of saponification of the components contained in the polyvinyl alcohol resin (C) differ from each other.

The polyvinyl alcohol resin (C) preferably contains a nonionic polyvinyl alcohol resin (C1) and an anionic polyvinyl alcohol resin (C2). In this case, preparing the slurry composition (Y) from the binder composition (X) makes it easier to adjust the degree of hydrophilicity of the slurry composition (Y). Thus, while the strength and flexibility of the sheet formed from the slurry composition (Y) are satisfactorily maintained, the sheet can have a higher degree of smoothness. Specifically, the anionic polyvinyl alcohol resin (C2) may have higher hydrophilicity than the nonionic polyvinyl alcohol resin (C1). Therefore, the anionic polyvinyl alcohol resin (C2) easily increases the viscosity of the binder composition (X), and therefore, when the binder composition (X) is formed into a sheet, repellency is less likely to occur at a surface of the sheet. The polyvinyl alcohol resin (C) contains not only the nonionic polyvinyl alcohol resin (C1) but also the anionic polyvinyl alcohol resin (C2), and therefore, the balance between the physical property and pH of the binder composition (X) and the slurry composition (Y) is easily adjusted. Thus, it is possible to reduce the occurrence of aggregation and gelation in the case of paste being produced from the slurry composition (Y). Furthermore, inclusion of the anionic polyvinyl alcohol resin (C2) easily suppresses heat shrinkage of the sintered product in a low temperature range in the case of sintering the slurry composition (Y) and the sheet. In this case, it is possible to make it more difficult for the sintered product to be cracked. Note that in the description in the specification, the low temperature range refers to, for example, a temperature range from 300° C. or higher to 500° C. or lower, and a high temperature range refers to, for example, a temperature range from 500° C. or higher to 700° C. or lower. However, the present invention is not limited to these temperatures. The ratio of the nonionic polyvinyl alcohol resin (C1) to the total amount of the nonionic polyvinyl alcohol resin (C1) and the anionic polyvinyl alcohol resin (C2) is preferably more than or equal to 30 wt. % and less than or equal to 90 wt. %, more preferably more than or equal to 40 wt. % and less than or equal to 85 wt. %.

The anionic polyvinyl alcohol resin (C2) preferably contains a polyvinyl alcohol resin (C21) having a carboxyl group. In this case, the polyvinyl alcohol resin (C21) has a carboxyl group in addition to the hydrophilic hydroxyl group. This further intensifies the interaction between the carboxyl group of the polyvinyl alcohol resin (C21) and the inorganic powder (B), which enables the strength of the sheet to be further improved. In addition, in this case, the balance between the physical property and the pH of the binder composition (X) and the slurry composition (Y) is more easily adjusted. Therefore, it is possible to reduce aggregation and gelation in the case of paste being produced from the slurry composition (Y), which enables the physical property of the sheet to be further improved.

Specific examples of commercially available products as the polyvinyl alcohol resin (C21) include: KL-506, KL-318, and KL-118 which are names of products manufactured by Kuraray Co., Ltd.; GOHSENX T-330, T-350, and T-330H which are names of products manufactured by Nippon Synthetic Chemical Co., Ltd.; and AP-17, AT-17, and AF-17 which are names of products manufactured by JAPAN VAM & POVAL CO., LTD.

When the polyvinyl alcohol resin (C) contains at least two kinds of components having different degrees of saponification, it is also preferable that the polyvinyl alcohol resin (C) contains: a component (C3) having a saponification degree of more than or equal to 85 mol % and less than or equal to 99 mol %; and a component (C4) having a saponification degree of more than or equal to 60 mol % and less than 85 mol %. In this case, the component (C3) has a higher percentage of hydroxyl groups than the component (C4), and therefore, the component (C3) can contribute to the improvement of the strength of the sheet formed from the binder composition (X) and the slurry composition (Y), while the component (C4) can contribute to the improvement of the flexibility of the sheet. Thus, it is possible to impart further increased strength and flexibility to the sheet to be formed from the binder composition (X) and the slurry composition (Y). Moreover, inclusion of the component (C4) having a relatively low saponification degree easily causes the slurry composition (Y) prepared from the binder composition (X) to flow so as to have a uniform thickness. That is, the component (C4) may further improve the leveling property of the slurry composition (Y). This can further improve the smoothness of the sheet formed from the slurry composition (Y). Furthermore, the inclusion of the component (C4) having a relatively low saponification degree may increase the temperature range of the pyrolysis in the case of sintering the slurry compositions (Y) and the sheet, and a rapid weight reduction due to heating is thus easily suppressed. Thus, when the component (C4) is contained, the heat shrinkage of the sintered product in the high temperature range is easily suppressed. This makes it difficult for the sintered product to be cracked. The component (C4) more preferably has a saponification degree of more than or equal to 60 mol % and less than 80 mol %. The ratio of the component (C3) to the total amount of the component (C3) and the component (C4) is preferably more than or equal to 30 wt. % and less than or equal to 90 wt. %, and more preferably more than or equal to 40 wt. % and less than or equal to 85 wt. %. Note that the component (C3) and the component (C4) are components distinguished from each other based on the saponification degree. Therefore, the component (C3) and the component (C4) may be either nonionic or anionic. Therefore, the component (C3) and the component (C4) may overlap with a component included in either the nonionic polyvinyl alcohol resin (C1) or the anionic polyvinyl alcohol resin (C2).

The nonionic polyvinyl alcohol resin (C1) preferably contains a nonionic polyvinyl alcohol resin (C11) having a saponification degree of more than or equal to 85 mol % and less than or equal to 99 mol % and a nonionic polyvinyl alcohol resin (C12) having a saponification degree of more than or equal to 60 mol % and less than 85 mol %, and the anionic polyvinyl alcohol resin (C2) preferably contains the anionic polyvinyl alcohol resin (C21) having the carboxyl group. That is, the polyvinyl alcohol resin (C) preferably contains the nonionic polyvinyl alcohol resin (C11), the nonionic polyvinyl alcohol resin (C12), and the anionic polyvinyl alcohol resin (C21). In this case, the nonionic polyvinyl alcohol resin (C11) has a higher percentage of hydroxyl groups than the nonionic polyvinyl alcohol resin (C12) and can therefore contribute to the improvement of the strength of the sheet to be formed from the binder composition (X) and the slurry composition (Y). In addition, since the polyvinyl alcohol resin (C21) has the carboxyl group, the contribution of the polyvinyl alcohol resin (C21) to the improvement of the strength of the sheet is even greater. On the other hand, the polyvinyl alcohol resin (C12) can contribute to the improvement of the flexibility of the sheet. Thus, it is possible to impart further increased strength and flexibility to the sheet formed from the binder composition (X) and the slurry composition (Y). Inclusion of the polyvinyl alcohol resin (C12) having a relatively low saponification degree can further improve the leveling property of the slurry composition (Y) prepared from the binder composition (X). This can further improve the smoothness of the sheet formed from the slurry composition (Y). Moreover, inclusion of the polyvinyl alcohol resin (C21) which is anionic in the slurry composition (Y) may increase the temperature range of the pyrolysis in the case of sintering the slurry compositions (Y) and the sheet, and a rapid weight reduction due to heating is thus easily suppressed. Thus, when the polyvinyl alcohol resin (C21) is contained, the heat shrinkage of the sintered product in the low temperature range is easily suppressed. This makes it more difficult for the sintered product to be cracked. The nonionic polyvinyl alcohol resin (C12) more preferably has a saponification degree of more than or equal to 60 mol % and less than 80 mol %. The ratio of the polyvinyl alcohol resin (C21) to the total amount of the polyvinyl alcohol resin (C11), the polyvinyl alcohol resin (C12), and the polyvinyl alcohol resin (C21) is preferably more than or equal to 10 wt. % and less than or equal to 50 wt. %, more preferably more than or equal to 20 wt. % and less than or equal to 40 wt. %.

It is also preferable that the polyvinyl alcohol resin (C1) contains a nonionic polyvinyl alcohol resin (C11) having a saponification degree of more than or equal to 85 mol % and less than or equal to 99 mol %, and the polyvinyl alcohol resin (C21) contains an anionic polyvinyl alcohol resin (C211) having a saponification degree of more than or equal to 60 mol % and less than 85 mol % and a carboxyl group. That is, the polyvinyl alcohol resin (C) preferably contains both the nonionic polyvinyl alcohol resin (C1) and the anionic polyvinyl alcohol resin (C211). In this case, the polyvinyl alcohol resin (C11) has a higher percentage of hydroxyl groups than the polyvinyl alcohol resin (C21) and can therefore contribute to the improvement of the strength of the sheet to be formed from the binder composition (X) and the slurry composition (Y). Although the ratio of the hydroxyl group in the polyvinyl alcohol resin (C211) is smaller than that in the polyvinyl alcohol resin (C11), the polyvinyl alcohol resin (C211) has the carboxyl group, and therefore, the polyvinyl alcohol resin (C211) can contribute to the improvement of the strength while the increased flexibility of the sheet is maintained. Thus, it is possible to impart further increased strength and flexibility to the sheet to be formed from the binder composition (X) and the slurry composition (Y). Furthermore, inclusion of the polyvinyl alcohol resin (C211) which is anionic and which has a relatively low saponification degree may increase the temperature range of the pyrolysis in the case of sintering the slurry compositions (Y) and the sheet, and a rapid weight reduction due to heating is thus easily suppressed. Thus, when the polyvinyl alcohol resin (C211) is contained, the heat shrinkage of the sintered product in the low temperature range is easily suppressed. In this case, it is possible to make it more difficult for the sintered product to be cracked. The saponification degree of the anionic polyvinyl alcohol resin (C211) having the carboxyl group is more preferably more than or equal to 60 mol % and less than 80 mol %. The ratio of the polyvinyl alcohol resin (C211) to the total amount of the polyvinyl alcohol resin (C11) and the polyvinyl alcohol resin (C211) is preferably more than or equal to 10 wt. % and less than or equal to 70 wt. %, and more preferably more than or equal to 15 wt. % and less than or equal to 60 wt. %.

Specific examples of commercially available products of the nonionic polyvinyl alcohol resin (C11) having a saponification degree of more than or equal to more than or equal to 85 mol % and less than or equal to 99 mol % include PVA-235, PVA-217, PVA-105, PVA-117, PVA-124, PVA-205, and PVA-224 which are names of product manufactured by Kuraray Co., Ltd.; Denka Poval K-05, K-17C, and H-17, B-20 which are names of products manufactured by Denka Corporation; and JC-33, JF-05, JM-23, and JP-03 which are names of product manufactured by JAPAN VAM & POVAL CO., LTD.

Specific examples of commercially products as the nonionic polyvinyl alcohol resin (C12) having a saponification degree of more than or equal to 60 mol % and less than 85 mol % include PVA-505, PVA-405, PVA-417, and PVA-420 which are names of products manufactured by Kuraray Co., Ltd.; GOHSENOL KL-05, KL-03, KH-20, KH-17, KP-08R, and NK-05R which are names of products manufactured by the Nippon Synthetic Chemical Industry Co., Ltd.; and JL-05E, JL-22E, JL-25E, and JR-05 which are names of products manufactured by JAPAN VAM & POVAL CO., LTD.

Note that the polyvinyl alcohol resin (C) may contain, for example, a cationic polyvinyl alcohol resin in addition to the nonionic polyvinyl alcohol resin (C1) and the anionic polyvinyl alcohol resin (C2). The polyvinyl alcohol resin (C) may contain the above-described component having a saponification degree of less than 60 mol %.

[Other Components]

The binder composition (X) may contain an appropriate solvent, additive, and the like. The binder composition (X) may contain, for example, water as a solvent. As described above, the binder composition (X) and the slurry composition (Y) contain at least two kinds of polyvinyl alcohol resins (C) different from each other, and therefore, even when water as a solvent is blended with the binder composition (X) and the slurry composition (Y), components of the binder composition (X) and the slurry composition (Y) are highly dispersible in water. Thus, the binder composition (X) and the slurry composition (Y) can have high storage stability. Also, because the binder composition (X) and the slurry composition (Y) have high dispersibility, the sheet formed from the binder composition (X) and the slurry composition (Y) has a high degree of smoothness.

The additive includes, for example, a plasticizer. Examples of the plasticizer may include an amine compound. Examples of the amine compound include at least one amino alcohol compound selected from the group consisting, for example, of diethanolamine, N-methylethanolamine, N-ethylethanolamine, N-t-butylethanolamine, N-methyldiethanolamine, N-n-butyldiethanolamine, N-t-butyldiethanolamine, N-lauryldiethanolamine, polyoxyethylenedodecylamine, polyoxyethylenelaurylamine, and polyoxyethylenestearylamine.

Other examples of the additive include a dispersant, a defoamant, a rheology-controlling agent, a wetting agent, an adhesiveness imparting agent, and a surfactant.

The binder composition (X) can be prepared by kneading and mixing the components described above by an appropriate method.

<Baking Slurry Composition>

The slurry composition (Y) contains the binder composition (X) described above, the inorganic powder (B), and water. In other words, the slurry composition (Y) contains the inorganic powder (B), water, and the polyvinyl alcohol resin (C), and the polyvinyl alcohol resin (C) further contains one or both of: a combination of at least two kinds of components, namely, a first component (a1) and a second component (a2) having degrees of hydrophilicity different from each other and a combination of at least two kinds of components, namely, a first component (b1) and a second component (b2) having different saponification degrees. Thus, the slurry composition (Y) can have high storage stability, and the sheet formed from the slurry composition (Y) has a high degree of smoothness while strength and flexibility are maintained.

Next, components which the slurry compositions (Y) according to the present embodiment may contain will be described in detail. Note that the components which the slurry composition (Y) may contain may overlap components which the binder composition (X) may contain. The description of the components described as components which the binder composition (X) may contain will be accordingly omitted.

[Inorganic Powder (B)]

The inorganic powder (B) may include an appropriate material depending on properties required by the sintered product to be formed from the inorganic powder (B). Specifically, the inorganic powder (B) contains at least one material selected from the group consisting, for example, of oxide, carbide, boride, sulfide, and nitride of metal. The metal contains at least one selected from the group consisting, for example, of Li, Pd, K, Be, Mg, B, Al, Si, Ca, Sr, Ba, Zn, Cd, Ga, In, lanthanide, actinide, Ti, Zr, Hf, Bi, V, Nb, Ta, W, Mn, Fe, Ca, and Ni. When the inorganic powder (B) contains a plurality of metal elements, the inorganic powder (B) may contain one or more components selected from the group consisting, for example, of Macerite, barium titanate, silicate glass, ferrite, lead glass, CaO.Al₂O₃.SiO₂-based inorganic glass, MgO.Al₂O₃.SiO₂-based inorganic glass, and LiO₂. Al₂O₃.SiO₂-based inorganic glass. The inorganic powder (B) particularly preferably contains at least one material selected from the group consisting of: an oxide containing aluminum, a nitride containing silicon, ferric oxide, and a barium titanate. The oxide containing aluminum includes at least one material selected from the group consisting, for example, of CaO.Al₂O₃.SiO₂-based inorganic glass, MgO.Al₂O₃.SiO₂-based inorganic glass, and LiO₂. Al₂O₃.SiO₂-based inorganic glass.

Note that the inorganic powder (B) of the present embodiment is an aggregate (powder) of powdery particles having a mean particle diameter of 10 μm or smaller. The mean particle diameter is a median diameter (D50) based on a volume calculated from particle size distribution values measured by, for example, a laser diffraction/scattering method. The mean particle diameter is obtainable with a commercially available particle size analyzer of a laser diffraction/scattering method.

[Solvent]

In the present embodiment, the slurry composition (Y) contains water as described above. Since the slurry composition (Y) contains the binder composition (X), components of the binder composition (X) are highly dispersible in water even when water is blended as a solvent. Thus, the slurry composition (Y) can have high storage stability. Since the slurry composition (Y) has high dispersibility, a sheet formed from the slurry composition (Y) has a high degree of smoothness.

The slurry composition (Y) may contain a solvent other than water. The solvent other than water may contain at least one selected from the group consisting, for example, of methanol, ethanol, propyl alcohol, isopropyl alcohol, propylene glycol monomethyl ether, ethylene glycol, ethylene glycol monoethyl ether, ethylene glycol monobutyl ether, ethylene glycol monotertiarybutyl ether, polyethylene glycol monomethyl ether, and 2-Hydroxyisobutyric acid methyl ester. Note that when the binder composition (X) contains a solvent, the solvent may be a solvent included in the slurry composition (Y). In this case, the slurry composition (X) may be prepared by further adding a solvent such as water according to the composition of the slurry composition (Y).

[Other Components]

Similarly to the binder composition (X), the slurry composition (Y) may contain components such as an additive other than the components described above. Examples of the additive include a dispersant, a plasticizer, a defoamant, a rheology-controlling agent, a wetting agent, an adhesiveness-imparting agent, and a surfactant. Specific examples of the additive and the like may be the same as [Other Components] in the binder composition (X).

The slurry composition (Y) according to the present embodiment can be prepared by mixing and stirring, for example, the inorganic powder (B), water, and optionally, additives such as a solvent and a dispersant to disperse these components, and then, mixing the components which can be included in the binder composition (X). The slurry composition (Y) may include an aqueous solution of the polyvinyl alcohol resin (C), that is, the polyvinyl alcohol resin (C) may be dissolved in water in advance and then blended with other components to prepare the slurry composition (Y).

The amounts of the components composing the slurry composition (Y) may be set accordingly, and for example, the amount of the polyvinyl alcohol resin (C) to a total amount of the inorganic powder (B) and the binder composition (X) of the slurry composition (Y) is preferably more than or equal to 1 wt. % and less than or equal to 20 wt. %, more preferably more than or equal to 4 wt. % and less than or equal to 15 wt. %, and even more preferably more than or equal to 7 wt. % and less than or equal to 11 wt. %.

The weight percentage of the inorganic powder (B) relative to the total solid content of the slurry composition (Y) is, for example, preferably more than or equal to 75 and less than or equal to 95, more preferably more than or equal to 80 and less than or equal to 95, and even more preferably more than or equal to 85 and less than or equal to 95.

The weight percentage of the polyvinyl alcohol resin (C) to the inorganic powder (B) in the slurry composition (Y) is, for example, preferably more than or equal to 1 and less than or equal to 20, more preferably more than or equal to 5 and less than or equal to 15, and even more preferably more than or equal to 8 and less than or equal to 12.

The binder composition has an amount more than or equal to 5 parts by mass and less than or equal to 20 parts by mass relative to 100 parts by mass of the inorganic powder (B) in the slurry composition (Y). In this case, when the sheet is formed from the slurry compositions (Y), the smoothness and flexibility of the sheet can be maintained.

The amount of water relative to the total amount of the slurry composition (Y) is preferably more than or equal to 6 wt. % and less than or equal to 45 wt. %, more preferably more than or equal to 8 wt. % and less than or equal to 40 wt. %, and even more preferably more than or equal to 10 wt. % and less than or equal to 37 wt. %.

Note that “total solids content of the slurry composition (Y)” refers to the total amount of the components excluding the solvent from the slurry composition (Y).

The slurry composition (Y) preferably has a pH of higher than or equal to 5 and lower than 8. In this case, agglomeration, gelation, and phase separation of the baking slurry composition are less likely to occur, and therefore, the storage stability of the baking slurry composition can be further improved. Thus, when a sheet is formed from the baking slurry composition, the sheet can be finished as a flexible sheet. The pH of the baking slurry composition is more preferably 6 or higher and 7 or lower. The pH of the baking slurry composition is adjustable, for example, by accordingly adjusting blending amounts of an amino alcohol compound (A) and the polyvinyl alcohol resin (C) (in the present embodiment, the anionic polyvinyl alcohol resin (C2)).

The slurry composition (Y) preferably has a viscosity of more than or equal to 1000 mPa·s and less than or equal to 5000 mPa·s. In this case, it is possible to make it particularly difficult for printing unevenness or repellency due to printing in the case of forming a coating from the slurry composition (Y) by application by a printing method to occur. This can further make the sheet formed from the slurry composition (Y) smooth and uniform. The viscosity of the slurry composition (Y) at 25° C. is more preferably more than or equal to 1000 mPa·s and less than or equal to 4000 mPa·s, and even more preferably more than or equal to 2000 mPa·s and less than or equal to 3000 mPa·s.

<Green-Sheet>

A green sheet contains inorganic powder (B) and at least two different kinds of polyvinyl alcohol resins (C). Thus, the green sheet of the present embodiment has a high degree of smoothness and flexibility. Therefore, forming a sheet from the slurry composition (Y) containing the components of the binder composition (X) enables flexibility to be imparted to the sheet as described above and thus enables the sheet to be hardly warped. This enables the adhesiveness of the sheet to a base material such as carrier film to be improved. Therefore, it is also possible to reduce the formation of cracks in the green sheet of the present embodiment.

The inorganic powder (B) and the polyvinyl alcohol resin (C) have the same configurations as those described in connection with the baking slurry composition, and therefore, duplicate descriptions thereof are omitted.

The green sheet can be produced, for example, as described below.

The slurry composition (Y) described above is prepared, is then applied to the base material, and is optionally dried, thereby obtaining the green sheet. Any appropriate method is adoptable as a method for applying the slurry composition (Y) to the base material, and examples of the method include a doctor blade method, a screen printing method, and a dispensing method. Any appropriate base material is adoptable as the base material to which the slurry composition (Y) is to be applied, and examples of the base material may include carrier film such as polyethylene terephthalate (PET) film.

The green sheet of the present embodiment is suitably utilizable as a ceramic green sheet for producing a monolithic ceramic capacitor or the like. Baking the green sheet pyrolyzes and removes components such as the polyvinyl alcohol resin (C), thereby sintering the inorganic powder (B). This forms a sintered product of the inorganic powder (B), and the sintered product may form appropriate elements such as electrodes and conductor wiring. For example, appropriate elements such as a conductive layer, a dielectric layer, and an insulating layer are producible from the green sheet. Specifically, for example, the green sheet is adoptable to produce a dielectric layer in a monolithic ceramic capacitor, an insulating layer in a ceramic circuit board, and the like. As described above, the green sheet of the present embodiment has increased strength and flexibility, and therefore, also when a plurality of the green sheets are stacked to produce a monolithic ceramic capacitor, reducing the thickness of the monolithic ceramic capacitor is easily possible.

The monolithic ceramic capacitor can be produced from the green sheet by, for example, the following method.

First, the green sheet is cut to obtain green sheets having an appropriate dimension, and a suitable number of the green sheets are stacked on each other according to the purpose. Subsequently, pressure is applied to compress the green sheets stacked, and then the green sheets stacked are put in a baking oven and are then baked. The dielectric layer in the monolithic ceramic capacitor, the insulating layer in the ceramic circuit board, and the like are thus produced.

The pressure to be applied to the green sheets stacked is not particularly limited but may be accordingly set depending on, for example, the number of stacked green sheets, and may be, for example, more than or equal to 10 MPa and less than or equal to 100 MPa. The baking condition may accordingly be set depending on the temperature at which the inorganic powder (B) is to be sintered, but the heating temperature may be set to, for example, 500° C. or higher and 1500° C. or lower, and the heating time may be set to, for example, 1 hour or longer and 24 hours or shorter. Note that the monolithic ceramic capacitor produced from the plurality of green sheets has been described above, but a single-layered ceramic capacitor may be produced from a single green sheet having an appropriate dimension.

### EXAMPLES

The present invention will be described further in detail with reference to examples below. However, the present invention is not limited to the following examples.

### (1) Preparation of Baking Slurry Compositions [Examples 1 to 8 and Comparative Examples 1 to 10]

Components shown in column A (columns corresponding to “inorganic powder”, “solvent”, “dispersant” and “amino alcohol compound”) in Tables 1 and 2 were placed in a ball mill and were dispersed by being stirred with the ball mill for 30 minutes. Subsequently, components in column B (columns corresponding to “defoamant and “polyvinyl alcohol resin”) in Tables 1 and 2 were further added and stirred in the ball mill for 8 hours for dispersion, thereby preparing a baking slurry composition.

Details of the components shown in Tables 1 and 2 are as shown below.

[Inorganic Powder]
Iron Oxide

[Dispersant]
Polyacrylic acid ammonium salt aqueous solution (MicroSol KE-511 manufactured by GOO chemical Co., Ltd., 40% aqueous solution)

[Plasticizer]
Diethanolamine

### [Defoamant]

SN-Defoamer 470 (manufactured by San Nopco Limited: a mixture of polyether, modified silicone compounds, and the like).
SN-Deformer 485 (manufactured by San Nopco Limited: a mixture of special polyether nonionic surfactant).

[Polyvinyl Alcohol Resin]
PVA-235 aqueous solution (manufactured by Kuraray Co., Ltd., concentration: 15%, degree of saponification: 88 mol %, and average degree of polymerization: 3500).
KL-506 aqueous solution (manufactured by Kuraray Co., Ltd., density: 30%, degree of saponification: 77 mol %, carboxyl group is contained, average degree of polymerization: 600).
KL-318 aqueous solution (manufactured by Kuraray Co., Ltd., density: 30%, degree of saponification: 88 mol %, carboxyl group is contained, average degree of polymerization: 1800).
PVA-217 aqueous solution (manufactured by Kuraray Co., Ltd., concentration: 20%, degree of saponification: 88 mol %, and average degree of polymerization: 1700).
GOHSENOL KL-05 aqueous solution (manufactured by Nippon Synthetic Chemical Co., Ltd., concentration: 30%, degree of saponification: 80 mol %, average degree of polymerization: 500).
PVA-505 aqueous solution (manufactured by Kuraray Co., Ltd., concentration: 30%, degree of saponification: 74 mol %, and polymerization degree: 500).
KL-118 aqueous solution (manufactured by Kuraray Co., Ltd., density: 30%, degree of saponification: 98 mol %, carboxyl group is contained, average degree of polymerization: 1800).
PVA-205 aqueous solution (manufactured by Kuraray Co., Ltd., concentration: 30%, degree of saponification: 88 mol %, and average degree of polymerization: 500).
PVA-105 aqueous solution (manufactured by Kuraray Co., Ltd., concentration: 30%, degree of saponification: 98 mol %, and average degree of polymerization: 500).
PVA-117 aqueous solution (manufactured by Kuraray Co., Ltd., concentration: 30%, degree of saponification: 98 mol %, and average degree of polymerization: 1700).

Note that the polyvinyl alcohol resins described in [Polyvinyl Alcohol Resin] were mixed by adjusting respective aqueous solutions containing the polyvinyl alcohol resins dissolved in water to achieve the concentrations described in the brackets. Values in the tables indicate the amounts of the respective aqueous solutions of the polyvinyl alcohol resins at the concentrations.

### (2) Evaluation Test

An evaluation test of aqueous baking binder resin compositions and sheets produced from the aqueous baking binder resin compositions in the examples and comparative examples obtained in (1) was conducted as described below. The results are shown in the tables below.

(2-1) Viscosity

The viscosities of the baking slurry compositions prepared in (1) were measured with RE-215SR/U, which is a model number of a product manufactured by Told Sangyo Co., Ltd. at 25° C. at a rotational speed of 50 rpms for 2 minutes.

(2-2) Slurry Stability (Storage Stability)

The baking slurry compositions prepared in (1) were left to stand at an ordinary temperature and stored for 4 weeks. During the 4-week period after adjustment of the baking slurry compositions, the baking slurry compositions were visually observed to check the presence or absence of phase separations, the presence or absence of sedimentation, and changes in appearance, and evaluated in accordance with the criteria described below.

A: Four weeks after the production, no change in appearance was observed.
B: Two weeks after the production, no change in appearance was observed, but a change was observed after 4 weeks.
C: A change was observed within 2 weeks after 1 day had elapsed since the production.
D: A state change was observed within 1 day after the production, and the slurry composition was in an uneven state.

(2-3) Pyrolysis Behavior

In (1), the baking slurry compositions were prepared without blending the inorganic powder described in [Inorganic Powder], coatings were produced from these compositions, and while the coatings were heated from a room temperature to 550° C. under the presence of air at a rate of temperature rise of 10° C./min, weight changes of the coatings were measured by using a difference dynamic differential thermal balance (model number TG8120 manufactured by Rigaku Corporation). As a result, a weight reduction rate at 550° C. relative to the weight of each baking slurry composition at the room temperature was calculated and evaluated according to the following criteria.

A: The weight reduction rate of the baking slurry composition at 550° C. was more than or equal to 99 wt. %, and no calcination residue was observed.
B: The weight reduction rate of the baking slurry composition at 550° C. was more than or equal to 99 wt. %, but few baking residues were observed.
C: The weight reduction rate of the baking slurry composition at 550° C. was more than or equal to 95 wt. % and less than 99 wt. %.
D: The weight reduction rate of the baking slurry composition at 550° C. was less than 95 wt. %, and a residue such as carbide was visually observed after the measurements were completed.

Note that in this evaluation, a coating produced from the baking slurry composition without adding the inorganic powder was evaluated for the sake of measurement, but this does not affect the evaluation of the pyrolysis behavior.

(2-4) Strength

The baking slurry compositions prepared in (1) were applied on polyethylene terephthalate (PET) film (dimension: 100 mm×100 mm) with a four-sided applicator (model No. 12 manufactured by Taiyu Kizai Co., Ltd.) to have a thickness of about 100 μm, and the coatings having been dried were peeled off slowly by hand in a direction perpendicular to the surface of the PET film, and the strengths of the coatings were evaluated in accordance with the following criteria.

A: The coating can be peeled from the PET film and can withstand tension. In addition, the strength is maintained after 2 weeks or more.
B: The coating can be peeled from the PET film and can withstand tension, but a reduction of the strength is observed after 2 weeks or more.
C: The coating can be peeled from the PET film but easily tears when pulled.
D: The coating cannot be peeled from the PET film or tears when peeled.

(2-5) Flexibility

The coatings formed on the PET film in (2-4) were bent to about 180° to check whether or not cracks were formed or breakage occurred in the coatings, and the coatings were evaluated according to the following criteria.

A: After the coating was bent at 180° more than 20 times, neither cracks nor breakage occurred in the coating.
B: After the coating was bent at 180° twice or more, neither cracks nor breakage occurred in the coating, but after the coating was bent 20 times or more, cracks and breakages occurred in the coating.
C: After the coating was bent at 180° more than twice, cracks and/or breakages occurred in the coating.
D: When the coating was bent at 180° at least once, cracks and cracks occurred in the coating.

(2-6) Unevenness (Printability 1)

The baking slurry compositions prepared in (1) were applied on peeling PET film (dimension: 100 mm×100 mm) with a four-sided applicator (model No. 112 manufactured by Taiyu Kizai Co., Ltd.) to have a thickness of about 100 μm to form a coating. The application unevenness of each coating thus obtained was observed and evaluated according to the following criteria.

A: The thickness of the coating is uniform, no application unevenness is observed, and the surface of the coating is smooth and uniform.
B: Although slight application unevenness is observed in the coating, the surface of the coating is substantially smooth and uniform.
C: Application unevenness is observed in an area less than 50% of the coating, and the surface of the coating is neither smooth nor uniform.
D: Application unevenness is observed in an area larger than or equal to 50% of the coating, and the surface of the coating is neither smooth nor uniform.

(2-7) Repellency (Printability 2) The baking slurry compositions prepared in (1) were applied on peeling PET film (dimension: 100 mm×100 mm) with a four-sided applicator (model No. 112 manufactured by Taiyu Kizai Co., Ltd.) to have a thickness of about 100 μm to form a coating. Repellency against the PET base of each coating thus obtained was observed and evaluated according to the following criteria.

A: The thickness of the coating is uniform, no repellency is observed, and the surface of the coating is smooth and uniform.
B: Although slight application repellency against the base is observed in the coating, the surface of the coating is substantially smooth and uniform.
C: Repellency against the base is observed in an area less than 50% of the coating, and the surface of the coating is neither smooth nor uniform.
D: Repellency against the base is observed in an area larger than or equal to 50% of the coating, and the surface of the coating is neither smooth nor uniform.

(2-8) Cracks After Baking

The coatings formed on the PET film in (2-4) were placed in an electric oven and were warmed from a room temperature to 600° C. under the presence of air at a rate of temperature rise of 10° C./min. After the temperature in the electric oven reached 600° C., the temperature of the coatings was kept at 600° C. for 1 hour. After 1 hour elapsed, the coatings were air-cooled to the room temperature, and the state of the coatings after baking was observed and evaluated according to the following criteria.

A: No crack is observed in the coating after baking, and a smooth and uniform coating is maintained.
B: Few cracks are observed in the coating after baking, but a substantially smooth and uniform coating is maintained.
C: Cracks are observed in an area less than 50% of the baked coating, and a smooth and uniform coating is not maintained.
D: Cracks are observed in an area larger than or equal to 50% of the baked coating, and a smooth and uniform coating is not maintained.

The results of the evaluations are given in the following Table 1 or 2.

TABLE 1

| | | | Example | | | | | | | |
|---|---|---|---|---|---|---|---|---|---|---|
| | | | 1 | 2 | 3 | 4 | 5 | 6 | 7 | 8 |
| A | Inorganic | Ferric Oxide | 20 | 20 | 20 | 20 | 20 | 20 | 20 | 20 |
| | Powder | | | | | | | | | |
| | Solvent | Water | 4 | 4 | 4 | 4 | 4 | 4 | 4 | 4 |
| | Dispersant | Polyacrylic Acid Ammonium | 0.2 | 0.2 | 0.2 | 0.2 | 0.2 | 0.2 | 0.2 | 0.2 |
| | | Salt Aqueous Solution | | | | | | | | |
| | Plasticizer | Diethanolamine | 0.3 | 0.3 | 0.3 | 0.3 | 0.3 | 0.3 | 0.3 | 0.3 |
| B | Defoamant | SN Defoamer 470 | 0.05 | 0.05 | 0.05 | 0.05 | 0.05 | 0.05 | 0.05 | 0.05 |
| | | SN Defoamer 485 | 0.05 | 0.05 | 0.05 | 0.05 | 0.05 | 0.05 | 0.05 | 0.05 |
| | Polyvinyl | PVA-235 Aqueous Solution | 6 | 6 | 7 | 4 | 6 | 6 | | 2 |
| | Alcohol | KL-506 Aqueous Solution | | | | | | 4 | | |
| | Resin | KL-318 Aqueous Solution | 4 | | | | 2 | | 4 | 4 |
| | | PVA-217 Aqueous Solution | | | | | | | 3 | |
| | | Gohsenol KL-05 Aqueous Solution | | | 3 | | | | | |
| | | PVA-505 Aqueous Solution | | | | 6 | 1 | | | |
| | | KL-118 Aqueous Solution | | 4 | | | | | | |
| | | PVA-205 Aqueous Solution | | | | | | | 1 | |
| | | PVA-105 Aqueous Solution | | | | | | | | 1 |
| | | PVA-117 Aqueous Solution | | | | | | | | 1 |
| Evaluation | Slurry | Viscosity [mPa · s] | 5000 | 3000 | 3000 | 2000 | 4000 | 3000 | 1000 | 1000 |
| | Characteristics | Slurry Stability | A | A | A | A | A | A | A | A |
| | | Pyrolysis Behavior | A | A | A | A | A | A | A | A |
| | Sheet | Strength | A | A | B | B | A | A | B | B |
| | Characteristics | Flexibility | B | B | A | A | A | A | A | A |
| | | Printability (Unevenness) | B | B | A | A | A | A | A | A |
| | | Printability (Repellency) | A | A | A | A | A | A | B | B |
| | | Cracks After Baking | B | B | A | A | A | A | A | A |

TABLE 2

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| A | Inorganic | Ferric Oxide | 20 | 20 | 20 | 20 | 20 | 20 | 20 | 20 | 20 | 20 |
| | Powder | | | | | | | | | | | |
| | Solvent | Water | 4 | 4 | 4 | 4 | 4 | 4 | 4 | 4 | 4 | 4 |
| | Dispersant | Polyacrylic Acid Ammonium | 0.2 | 0.2 | 0.2 | 0.2 | 0.2 | 0.2 | 0.2 | 0.2 | 0.2 | 0.2 |
| | | Salt Aqueous Solution | | | | | | | | | | |
| | Plasticizer | Diethanolamine | 0.3 | 0.3 | 0.3 | 0.3 | 0.3 | 0.3 | 0.3 | 0.3 | 0.3 | 0.3 |
| B | Defoamant | SN Defoamer 470 | 0.05 | 0.05 | 0.05 | 0.05 | 0.05 | 0.05 | 0.05 | 0.05 | 0.05 | 0.05 |
| | | SN Defoamer 485 | 0.05 | 0.05 | 0.05 | 0.05 | 0.05 | 0.05 | 0.05 | 0.05 | 0.05 | 0.05 |
| | Polyvinyl | PVA-235 Aqueous Solution | 14 | | | | | | | | | |
| | Alcohol | KL-506 Aqueous Solution | | 7 | | | | | | | | |
| | Resin | KL-318 Aqueous Solution | | | 7 | | | | | | | |
| | | PVA-217 Aqueous Solution | | | | 10 | | | | | | |
| | | Gohsenol KL-05 Aqueous | | | | | 7 | | | | | |
| | | Solution | | | | | | | | | | |
| | | PVA-505 Aqueous Solution | | | | | | 7 | | | | |
| | | KL-118 Aqueous Solution | | | | | | | 7 | | | |
| | | PVA-205 Aqueous Solution | | | | | | | | 7 | | |
| | | PVA-105 Aqueous Solution | | | | | | | | | 7 | |
| | | PVA-117 Aqueous Solution | | | | | | | | | | 7 |
| Evalu- | Slurry | Viscosity [mPa · s] | 2000 | 1000 | 7000 | 500 | 100 | 100 | 7000 | 100 | 100 | 500 |
| ation | Charac- | Slurry Stability | A | B | C | C | C | C | C | C | C | C |
| | teristics | Pyrolysis Behavior | A | B | C | A | A | A | C | A | A | A |
| | Sheet | Strength | A | C | A | C | C | C | A | C | C | B |
| | Charac- | Flexibility | C | A | C | C | A | A | C | C | C | C |
| | teristics | Printability (Unevenness) | B | A | D | B | A | A | D | C | C | B |
| | | Printability (Repellency) | A | B | A | C | D | D | A | D | D | C |
| | | Cracks After Baking | C | C | D | D | D | D | D | D | D | D |

### SUMMARY

As can be seen from the above description, a green sheet producing binder composition according to a first aspect of the present invention is a binder composition for producing a green sheet. The binder composition contains a polyvinyl alcohol resin (C), and the polyvinyl alcohol resin (C) contains at least two kinds of components having degrees of hydrophilicity different from each other.

According to the first aspect, the binder composition has storage stability in an aqueous system in the case of a slurry composition produced from the binder composition, and while a high degree of smoothness in the case of a sheet formed from the binder composition is maintained, it is possible to impart strength and flexibility to the sheet.

In a green sheet producing binder composition of a second aspect referring to the first aspect, the polyvinyl alcohol resin (C) contains at least two kinds of components having different degrees of saponification.

According to the second aspect, when the binder composition is formed into a sheet, it is possible to impart satisfactory strength and flexibility while a higher degree of smoothness is maintained.

A green sheet producing binder composition of a third aspect referring to any one of the first or second aspect includes: a component (C3) having a saponification degree of more than or equal to 85 mol % and less than or equal to 99 mol %; and a component (C4) having a saponification degree of more than or equal to 60 mol % and less than 85 mol %.

According to the third aspect, the component (C3) has a higher percentage of hydroxyl groups than the component (C4). Therefore, the component (C3) can contribute to the improvement of the strength of the sheet produced from the binder composition (X) and the slurry composition (Y). On the other hand, the component (C4) can contribute to an improvement in the flexibility of the sheet. Thus, it is possible to impart more satisfactory strength and flexibility to the sheet to be produced from the binder composition (X) and the slurry composition (Y).

A green sheet producing binder composition of a fourth aspect referring to any one of the first to third aspects contains a nonionic polyvinyl alcohol resin (C1) and an anionic polyvinyl alcohol resin (C2).

According to the fourth aspect, it is possible to further improve the strength of the sheet to be produced from the baking slurry composition.

In a green sheet producing binder composition of a fifth aspect referring to the fourth aspect, the anionic polyvinyl alcohol resin (C2) contains a polyvinyl alcohol resin (C21) having a carboxyl group.

According to the fifth aspect, it is possible, when the baking slurry composition is prepared, to further improve the storage stability of the slurry composition. It is also possible, when the baking slurry composition is formed into a sheet, to impart satisfactory strength and flexibility to the sheet while a higher degree of smoothness of the sheet is maintained.

In a green sheet producing binder composition of a sixth aspect referring the fifth aspect, the polyvinyl alcohol resin (C1) contains: a nonionic polyvinyl alcohol resin (C11) having a saponification degree of more than or equal to 85 mol % and less than or equal to 99 mol %; and a nonionic polyvinyl alcohol resin (C12) having a saponification degree of more than or equal to 60 mol % and less than 85 mol %.

According to the sixth aspect, the nonionic polyvinyl alcohol resin (C11) has a higher percentage of hydroxyl groups than the nonionic polyvinyl alcohol resin (C12) and can therefore contribute to the improvement of the strength of the sheet to be produced from the baking slurry composition. In addition, since the polyvinyl alcohol resin (C21) has a carboxyl group, the contribution of the polyvinyl alcohol resin (C21) to the improvement of the strength of the sheet is even greater. On the other hand, the polyvinyl alcohol resin (C12) can contribute to the improvement of the flexibility of the sheet. Thus, it is possible to impart more satisfactory strength and flexibility to the sheet to be produced from the binder composition (X) and the slurry composition (Y).

In a green sheet producing binder composition of a seventh aspect referring the fifth aspect, the polyvinyl alcohol resin (C1) contains a nonionic polyvinyl alcohol resin (C12) having a saponification degree of more than or equal to 85 mol % and less than or equal to 99 mol %. The nonionic polyvinyl alcohol resin (C12) contains an anionic polyvinyl alcohol resin (C211) having a saponification degree of more than or equal to 60 mol % and less than 85 mol % and a carboxyl group.

According to the seventh aspect, the polyvinyl alcohol resin (C5) has a higher percentage of hydroxyl groups than the polyvinyl alcohol resin (C20) and can therefore contribute to the improvement of the strength of the sheet to be produced from the binder composition (X) and the slurry composition (Y). Although the ratio of the hydroxyl group in the polyvinyl alcohol resin (C21) is smaller than that in the polyvinyl alcohol resin (C5), the polyvinyl alcohol resin (C21) has a carboxyl group, and therefore, the polyvinyl alcohol resin (C21) can also contribute to the improvement of the strength while the increased flexibility of the sheet is maintained. Thus, it is possible to impart more satisfactory strength and flexibility to the sheet to be produced from the binder composition and the baking slurry composition.

A baking slurry composition of an eighth aspect contains the binder composition of any one of the first to seventh aspects, inorganic powder (B), and water.

According to the eighth aspect, the baking slurry composition has high storage stability. Moreover, while a high degree of smoothness in the case of a sheet formed from the baking slurry composition is maintained, it is possible to impart strength and flexibility to the sheet.

In a baking slurry composition of a ninth aspect referring to the eighth aspect, the binder composition has an amount more than or equal to 5 parts by mass and less than or equal to 20 parts by mass relative to 100 parts by mass of the inorganic powder (B).

According to the ninth aspect, when a sheet is formed, it is possible to impart satisfactory strength and flexibility to the sheet while a higher degree of smoothness of the sheet is maintained.

A method for manufacturing a green sheet of a tenth aspect includes applying and drying the baking slurry composition of the eighth or ninth aspect.

The tenth aspect provides a green sheet having a high degree of smoothness and satisfactory strength and flexibility.

A method for manufacturing a sintered product of an eleventh aspect includes sintering a green sheet obtained by the method of the tenth aspect.

According to the eleventh aspect, the green sheet has a high degree of smoothness and increased flexibility. Therefore, also when a plurality of the green sheets are stacked to produce a monolithic ceramic capacitor, reducing the thickness of the monolithic ceramic capacitor is easily possible.

A method for manufacturing a monolithic ceramic capacitor of a twelfth aspect includes sintering a stack obtained by stacking a plurality of green sheets obtained by the method of the tenth aspect.

According to the twelfth aspect, reducing the thickness of the monolithic ceramic capacitor is possible when a plurality of sheets are stacked.

1. A binder composition for producing a green sheet, the binder composition comprising a polyvinyl alcohol resin (C),
the polyvinyl alcohol resin (C) containing at least two kinds of components having degrees of hydrophilicity different from each other.

2. The binder composition of claim 1, wherein
the polyvinyl alcohol resin (C) contains at least two kinds of components having degrees of saponification different from each other.

3. The binder composition of claim 2, wherein
the polyvinyl alcohol resin (C) contains
a component (C3) having a saponification degree of more than or equal to 85 mol % and less than or equal to 99 mol %, and
a component (C4) having a saponification degree of more than or equal to 60 mol % and less than 85 mol %.

4. The binder composition of claim 1, wherein
the polyvinyl alcohol resin (C) contains
a nonionic polyvinyl alcohol resin (C1) and
an anionic polyvinyl alcohol resin (C2).

5. The binder composition of claim 4, wherein
the anionic polyvinyl alcohol resin (C2) contains a polyvinyl alcohol resin (C21) having a carboxyl group.

6. The binder composition of claim 5, wherein
the nonionic polyvinyl alcohol resin (C1) contains
a nonionic polyvinyl alcohol resin (C11) having a saponification degree of more than or equal to 85 mol % and less than or equal to 99 mol %, and
a nonionic polyvinyl alcohol resin (C12) having a saponification degree of more than or equal to 60 mol % and less than 85 mol %.

7. The binder composition of claim 5, wherein
the polyvinyl alcohol resin (C1) contains a nonionic polyvinyl alcohol resin (C11) having a saponification degree of more than or equal to 85 mol % and less than or equal to 99 mol %, and
the polyvinyl alcohol resin (C21) contains an anionic polyvinyl alcohol resin (C211) having a saponification degree of more than or equal to 60 mol % and less than 85 mol % and a carboxyl group.

8. A baking slurry composition, comprising:
the binder composition of claim 1;
inorganic powder (B); and
water.

9. The baking slurry composition of claim 8, wherein
the binder composition has an amount more than or equal to 5 parts by mass and less than or equal to 20 parts by mass relative to 100 parts by mass of the inorganic powder (B).

10. A method for manufacturing a green sheet, the method comprising:
applying and drying the baking slurry composition of claim 7.

11. A method for manufacturing a sintered product, the method comprising:
sintering a green sheet obtained by the method of claim 10.

12. A method for manufacturing a monolithic ceramic capacitor, the method comprising
sintering a stack obtained by stacking a plurality of green sheets obtained by the method of claim 10.
